(19) United States
(12) Patent Application Publication
(10) Pub. No.: US 2011/0122879 A1
(43) Pub. Date: May 26, 2011

(54) SYSTEM FOR SEAMLESS CONNECTION OF REAL AND VIRTUAL NETWORKS

(75) Inventors: George F. Elmasry, Howell, NJ (US); Benjamin Hoe, Marlboro, NJ (US)

(73) Assignee: D & S Consultants, Inc., Eatontown, NJ (US)

(21) Appl. No.: 12/622,938

(22) Filed: Nov. 20, 2009

(51) Int. Cl. H04L 12/28

(52) U.S. Cl. 370/401

(57) ABSTRACT

A device, based on a standard router, that provides a seamless connection between real nodes and virtual, simulated nodes for the flow of both control and application traffic, such that new technologies and applications can be tested on a simulated large scale network with only a few real nodes.

### FIELD OF THE INVENTION

This invention is related to the fields of network simulations and testing, and, in particular, to systems involving large scale mix of real and simulated networks.

### BACKGROUND OF THE INVENTION

It may often be necessary and desirable to test new technologies and network protocols in a real environment under real circumstances. However, many network-based technologies and applications require the use of a large scale network to fully test their capabilities.

Unfortunately, it is often not practical to test such technologies and applications due to several factors, including, among others, the cost of setting up such a testing environment, especially when the infrastructure required could include hundreds or thousands of network nodes. However, it would be desirable to somehow have the advantages of testing in a real, large scale network, while only incurring the costs associated with setting up a small scale network.

The network modeling and simulation community, the network testing community and the network protocols development community all face a major challenge where there is a need to construct a representation of a large scale network with a small scale of real network nodes (e.g., 2 or 3 nodes) scaled in a lab environment. The capability to scale a small scale network into a large scale network is essential in order to examine the scalability of new networking and communication products and protocols being developed or tested. This representation of a large scale network environment requires that control traffic, such as the Open Shortest Path First (OSPF) protocol and the Border Gateway Protocol (BGP), as well as the application traffic, are able to flow seamlessly between real nodes and the virtual nodes used for scaling the network, as if they are all real nodes.

Hardware-in-the-loop (“HITL”) and software-in-the-loop (“SITL”) simulations are well known simulation techniques in various fields. Hardware-in-the-loop generally refers to a real hardware that is a part of the larger network environment, which can be a simulated network or a test network. The real hardware can include one or more network components (such as a router or a satellite terminal). A software-in-the-loop test environment is one in which software is used to simulate the environment in which the new technology or application will operate. Network-in-the-Loop (NITL) is an umbrella capability that encompasses SITL, HITL, real network components, and simulated network components.

With respect to network applications and technologies, the practical impossibility of establishing a large scale testing environment leaves only limited options if full testing is required. One such option would be the use of an actual small scale network, which can be scaled to a large scale network through the use of virtual (simulated) networks, resulting in a large scale test environment which is part-real and part-virtual. One problem with this approach, however, is integrating the real components of the network and the virtual components of the network such that the simulated large scale network looks and acts like an actual large-scale network to the technology being tested.

### SUMMARY OF THE INVENTION

This invention defines a system for creating a seamless connection between real and virtual (simulated) networks. More particularly, the invention creates a gateway device which is capable of making the application and control traffic flow seamlessly between one or more real (actual) network nodes and one or more simulated (virtual) network nodes, between the network hardware components, and between the network software components. This gateway device enables the creation of an environment that can contain SITL, HITL, real network hardware, real network software, and the simulated network. The device will therefore be referred to herein as the ITL gateway.

The invention creates the ITL gateway as an actual hardware node as opposed to a simulated node, and allows a real small scale network to be extended to a large scale network where the virtual or simulated network is used for scaling.

In this invention, the real nodes see and interact with the ITL gateway as if it were an actual hardware gateway node. The simulated nodes and real nodes are able to interact with each other, through the ITL gateway, as though they are all part of a large-scale real network.

The invention also allows creating protocol development environments where the development platform can consist of a few actual nodes and a large number of simulated nodes that scale the protocol development platform to a large number of nodes seamlessly to test the protocol scalability.

The invention is preferably based on a software router, typically a computer running open source Linux routing software, with added hardware ports and full gateway capabilities which allow real networks to communicate with each other. The router software is then modified to create a gateway that dedicates some interfaces (ports) to real networks and others to virtual or simulated networks. This can solve a unique challenge that is well known to the experts in the network modeling and simulation community. Currently, no solution is available that can provide seamless flow between real and simulated networks with full control traffic as well as user traffic. The present invention provides this functionality, for example, allowing control traffic protocols such as OSPF as well as other gateway capabilities such as BGP to work seamlessly between the virtual and the real sides. The invention also allows the user or application traffic to flow seamlessly between the real and the simulated sides of the ITL gateway.

A topology of the virtual portion(s) of the network can be loaded into the router, such that the virtual network topology, residing behind certain interfaces of the ITL gateway, appears as actual hardware nodes to the real parts of the network. The virtual topology is created in the form of a link state database or a script.

To enable the seamless integration of the real and virtual parts of the network, the invention utilizes an exception routing technique, which is a technique for regulating packet flow according to user-definable rules. The exception routing permits routing of the user traffic and the protocol traffic between the real network and the simulated network, and between non-IP networks and IP-based networks. This technique allows bypassing of standard routing rules (such as OSPF) and relies on user-defined rules for user-defined traffic types.

The use of exception routing is also uniquely combined with standard routing. This combined use of exception routing and standard routing in the single ITL gateway hardware platform enables the creation of a simulated heterogeneous network that could contain IP-based network components, non-IP based network components, and networks implemented in proprietary protocols. This integrated use of exception routing and standard routing protocols is one novel aspect of the invention.

Based on the virtual topology that is represented by the ITL gateway and the exception routing rules, all control traffic, such as commercial standard OSPF and military specific mobile ad-hoc routing traffic (e.g., ROSPF), can flow seamlessly between the real nodes and the virtual network components.

The real nodes can form routing tables that treat the simulated nodes just as real nodes, and route seamlessly to the simulated nodes, through the ITL gateway, while the ITL gateway can form routing tables that see both the real nodes and the simulated nodes, and can act as a gateway between the two sides.

Utilizing this device, any real node or real subnet can communicate with any simulated node or simulated subnet through the combined use of a standard control protocol and the exception routing rules in the ITL gateway. The exception routing rules allow any application packets to be routed to any user defined destination node with no modification of packet contents and no changes in the standard routing rules. This means that the invention enables the exception routing to have a higher priority over standard routing protocols in regulating traffic flows.

Exception routes are created in the ITL gateway to create specific paths between certain interfaces that allow the tester or protocol developer to bypass standard routing protocols and route traffic between real and simulated nodes, a capability that provides the desired scalability of a small-scale network to a large-scale network.

### BRIEF DESCRIPTION OF THE DRAWINGS

FIG. 1 shows the hardware architecture of the device of the present invention.

FIG. 2 shows the software architecture of the device of the present invention.

FIG. 3 shows a graphical user interface to a utility used to build user-defined exception rules.

FIG. 4 shows a schematic diagram of a large scale testing system, having multiple real nodes from one or more sub-networks and multiple virtual networks.

FIG. 5 shows an example in schematic form of the use of the device of the present invention for the testing of a VoIP application with a simulated service provider's network.

### DETAILED DESCRIPTION OF THE INVENTION

Hardware Architecture

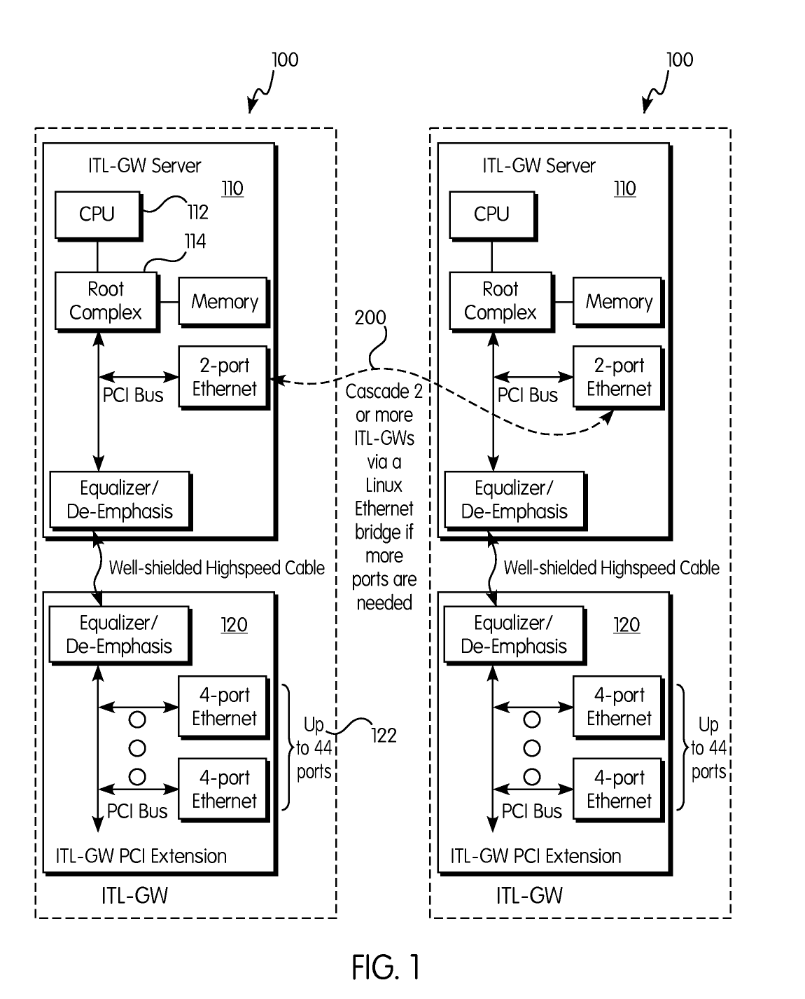

The device 100 of this invention, shown schematically in FIG. 1, is based on a PC or server 110 having a general processor 112, such as Intel or AMD CPU which is equipped with routing software, preferably an open source routing software 114, such as Linux Zebra, which results in a full-function software router with gateway capabilities such as BGP, OSPF, etc. The use of open source server software is preferred because of the ability to modify the source of this software to add the inventive features of the ITL gateway.

Physical network ports may be added to the ITL gateway by adding standard off-the-shelf cards to the PCI bus of the computer. The number of physical network interface ports in gateway node 110 can be further increased by using a PCI extension 120 which can add up to 44 additional physical ports 122 to server 110. When the PCI bus is no longer able to accept more ports, the number of ports may be further expanded by cascading, multiple NITL-gateways via a Linux Ethernet Bridge 200, resulting in a large number of physical ports.

Software Architecture

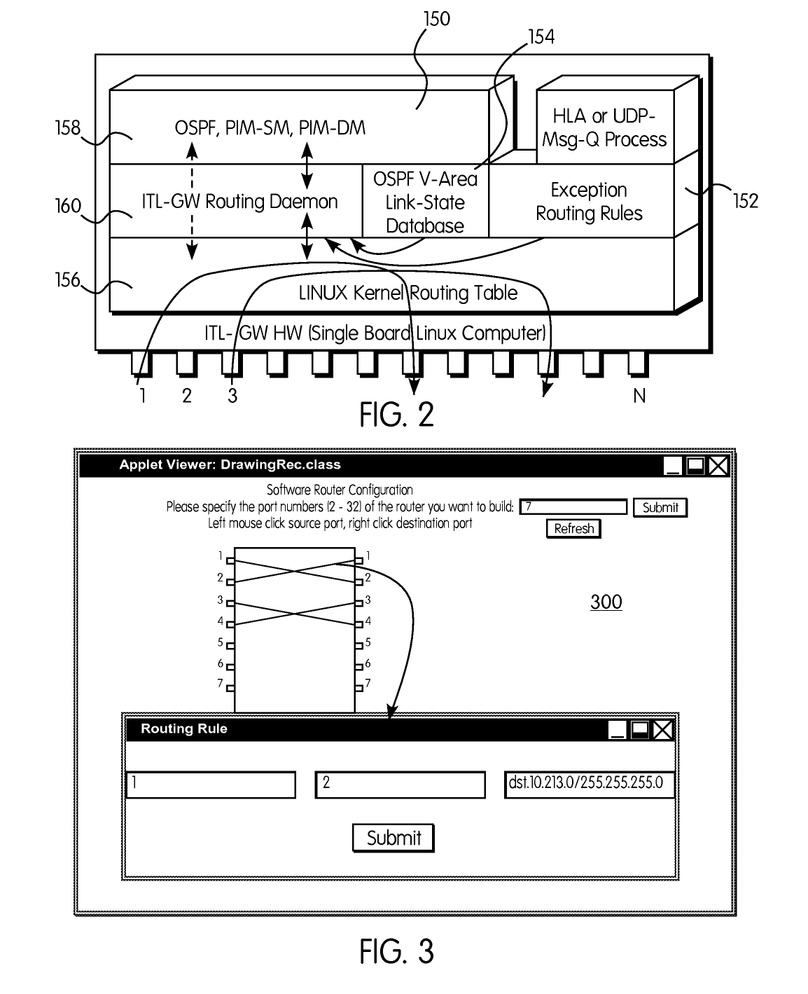

The software architecture of device 100 of the present invention is shown in FIG. 2. Standard gateway capabilities from commercially available systems, such as Cisco routers, rely on discovered routes through standard routing protocols for packet routing. The device of the present invention, however, relies on routes generated through three mechanisms: 1) standard routing protocols 150, 2) exception routing rules 152, and 3) a virtual topology database 154, all shown in FIG. 2.

As illustrated in FIG. 2, the software consists of a routing protocol stack, with ITL gateway routing daemon 160 sitting between the Linux kernel 156 and standard routing protocols such as OSPF and PIM 158.

The ITL gateway routing daemon 160 intercepts incoming packets and checks to see if there is an exception routing rule 152 that applies to the intercepted packet. The rules for routing the packets can be based on any number of criteria, such as source port, type of packet, destination IP address, etc., using Boolean expression to combine criteria. If no rule is found that applies to the packet, the packet is released to the standard routing protocols 158.

The ITL gateway exception routing rule syntax is as follows:

source_port, destination_port: exception_condition_expression

The exception condition expression uses the standard computer science logical operator sets. Following are three examples of ITL gateway exception routing rules:

| | |
|---|---|
| 1, 2: | TCP AND dst 10.2.1.0/255.255.255.0 |
| 1, 3: | UDP AND dst 10.2.1.0/255.255.255.0 |
| 10, 12: | !TCP AND !UDP AND 10.2.1.0/255.255.255.0 |
| 11, 13: | ALL |

In the first two examples, all TCP traffic received on port 1 targeting destination 10.2.1.0 is forwarded to port 2 and all UDP traffic targeting destination 10.2.1.0 from port 1 is forwarded to port 3. In the third example, all non-TCP and non-UDP traffic targeting destination 10.2.1.0 from port 10 will be forwarded to port 12. In the last example, all traffic from Port 11 will be forwarded to Port 13. Note that “port” in this context means the actual physical network port in the ITL gateway.

Exception routing rules can be created in two ways. The user can create a plain text routing file conforming to the format previously described or can interactively create the rules using the ITL gateway GUI, shown in FIG. 3 as reference number 300. The process employs a click-and-drag capability to connect source and destination ports. For example, IN port 1 can be connected to OUT port 2 and the routing rule specified as “dst 10.2.13.0/255.255.255.0”. This will result in any traffic from port 1 that is targeting the destination subnet “10.2.13.0” to be forwarded to port 2. FIG. 3 shows an example of a 7 port ITL gateway, but GUI 300 will reflect the actual number of ports present in the ITL gateway. Notice that each of the ports may be used as either an IN port or an OUT port, allowing the user to create any number of exception routes needed to execute a test or a specific protocol.

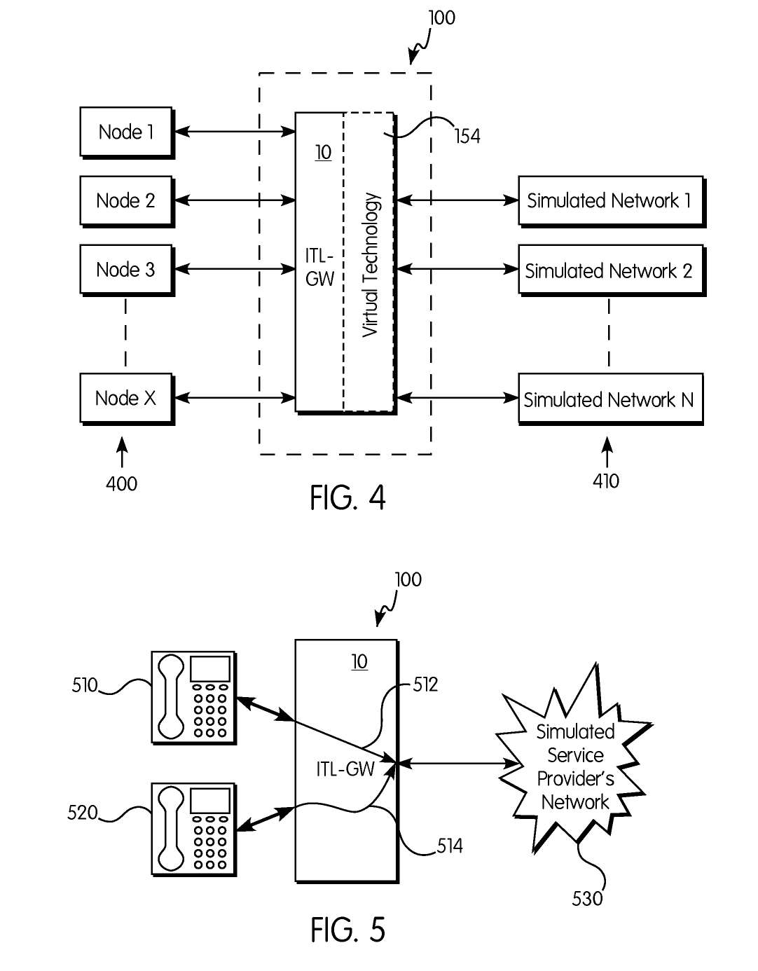

FIG. 4 is a schematic diagram of a large scale testing system, having multiple real nodes 400 from one or more sub-networks and multiple virtual networks 410. Note that the virtual networks are implemented using standard, commercially-available network simulation software and may be of any complexity. It is preferred that each external network 400 have at least one start node, which may receive packets from ITL gateway 10 and at least one end node which may send packets from the virtual network 400 to the ITL gateway 10. The start and end nodes, and any other nodes which may send or receive packets from ITL gateway 10 should be connected to physical ports on ITL gateway 10.

Thus, using the exception rules, packets may be routed from real nodes 400 to virtual networks 410. Note that the ITL gateway has full gateway capability in the sense that a virtual topology over one interface influences the way the routing tables are formed on real nodes connected to another interface. The ITL gateway relates the virtual topology to the real network topology by making the real nodes discover the simulated nodes through the ITL gateway.

The ITL gateway daemon 160 generates and maintains the routing database and routing control packets on behalf of the simulated network. This capability is achieved through the use of the virtual link state database that represents the virtual network topology 154. Virtual network topology 154 is the topology of the simulated network. Virtual link state database 154 is denoted as “OSPF V-Area Link-State Database” in FIG. 2. ITL gateway 10 uses virtual link state database 154 to represent the simulated network and to communicate with the real networks, and to send and receive control traffic such as OSPF on behalf of the virtual network. The use of the virtual topology database allows the real network to see the simulated network as real, and enables the seamless communication between the real and the simulated networks.

Notice that this capability can be used to route non-IP data from one network to another. For example, a test scenario can require that a proprietary network that is not IP-based routes IP packets between IP-based networks or nodes. This can be achieved by creating one or more exception conditions that routes all the traffic from the source IP port to the port connected to the non-IP-based network and one or more other exception conditions that routes the traffic coming from the port connected to the non-IP-based network to the destination port.

Before ITL gateway 10 is activated into an operational state, it will be loaded with the predefined exception routing rules 152 and virtual topology database 154, which will be loaded into the system by ITL gateway routing software daemon 160. During the operational state, ITL gateway 10 will always look at the exception routing rules 152 first for the packet routing decision. If there are no matching rules for the incoming traffic, ITL gateway routing daemon 160 will continue to look at virtual topology database 154 and the standard routing table 156.

Note that the virtual link state database 154 is loaded into the device upon startup and serves to seed the normal routine tables with simulated nodes. The normal method of building a routing table, in which the router discovers nodes connected to it, is then allowed to run to build the routine tables, where the algorithm used to build the routine tables will “discover” the simulated nodes. Note also that router connected to any of the ports of the ITL gateways, either directly or indirectly, will also be able to discover both real and simulated nodes in the routine tables of the ITL gateway.

This invention will be further explained through a system used for large scale testing. In this case, a small scale real network is expanded using simulated or virtual environments, to test newly developed protocols in large scale settings.

FIG. 4 shows a possible system with multiple real nodes 400 (that can be from the same or from different networks) and multiple virtual or simulated subnets 410. As the figure shows, the virtual topology 154 inserted into ITL gateway 10 reflects the topology of simulated networks 410, and makes them look like real networks to real nodes 400.

The exception routing rules 152 explained above play a major role. Consider a test case where a packet is flowing from node 1, a real node, and is eventually destined for node 2, also a real node, after it passes through one or more simulated nodes in the simulated network. Without the exception routes, the packet would have entered the ITL gateway at node 1 and would have been routed, by the standard routing protocols, straight to node 2 without ever entering the simulated networks. As such, the simulated networks would not have had an opportunity to affect the behavior of the system being tested.

With the exception routes, the packet enters ITL gateway 10 and is routed to a virtual subnet, for example simulated network 1, to get the effect of a large scale system. As the packet leaves the first virtual subnet and enters ITL gateway 10 again, it could be routed to another virtual subnet, for example, simulated network 2, or to real node 2, based on the test scenario and testing requirements. Test scenarios would be used to decide how exception routes are generated to meet the requirements needed for a specific test.

A specific example for testing a VoIP application is shown in FIG. 5. The scenario may be used, for example, to test the performance of VoIP over multiple networks, including some service provider's network with satellite links. A virtual or simulated network reflecting the service provider's network can be used.

In this scenario, VoIP terminals 510 and 520 wish to communicate with each other. Traffic will flow from terminal 510 into ITL gateway 10 to virtual network 530, which may simulate the service provider's network, and back through ITL gateway 10 to node 520. ITL gateway 10 would need to be configured, using the exception routing rules, for an exception route that forces the VoIP flow from node 510 to enter the virtual subnet 530 representing the service provider's network. As the packet leaves virtual subnet 530, it will enter ITL gateway 10 again where it would be routed, based on the discovered routing table, to node 520. FIG. 5 shows this simple example where two exception routes are generated. Line 512 represents an exception route created to route traffic from the VoIP node 510 to the simulated service provider's network, otherwise the flow would have gone directly from VoIP node 510 to VoIP node 520. Line 514 represents an exception route created to route traffic from VoIP node 520 to the simulated service provider's network.

The invention combines exception routes and discovered routes to create a passage from VoIP node 510 to virtual subnet 530 to VoIP node 520. With these testing capabilities, the actual service provider's large network (which could be very costly to build) would not be needed for testing purposes. Instead, the simulation could be run in a seamless manner in a lab testing environment.

More complex scenarios can also be tested where a packet is made to traverse a passage of multiple simulated networks and multiple real nodes.

This invention has been explained using specific examples and embodiments, but is not meant to be limited thereby. Modifications that are within the knowledge of one skilled in the art are meant to be included in the scope of the invention.

We claim:

1. A device for connecting real and simulated network nodes comprising:
a. a processor and memory;
b. a plurality of network ports;
c. standard routing software, installed on said device; and
d. software, executing on said processor, comprising:
a database containing one or more exception routing rules;
a virtual topology database providing a topology of simulated nodes; and
a routing daemon;
wherein said routing daemon intercepts incoming traffic, and determines if an exception rule that applies to said traffic exists, said exception rule defining a path between a real node and a simulated node, and, if so, routes said traffic according to said exception routing rule.

2. The device of claim 1 wherein said traffic is organized into data packets.

3. The device of claim 1 wherein said routine daemon can route both application and control traffic.

4. The device of claim 1 wherein said virtual topology database in loaded into said system prior to operation, and further wherein said virtual topology database allows simulated nodes to appear real to real nodes connected to said system.

5. The device of claim 1 wherein the topology of real nodes connected to said system is seen by simulated nodes as part of the simulated topology.

6. The device of claim 1 wherein simulated nodes defined in said virtual topology database are simulated on an external machine connected to one or more of said plurality of network ports.

7. The device of claim 1 wherein if no exception routing rule is defined that applies to specific traffic, the traffic is routed based on standard routing protocol contained in said standard routing software.

8. The device of claim 1 further comprising software providing a graphical user interface to allow a user to create said exception routine rules.

9. The device of claim 4 wherein said virtual topology is stored in the form of a link-state database.

10. A device for connecting real and simulated network nodes based on a standard router, modified with software comprising:
a database containing one or more exception routing rules;
a virtual topology database providing a topology of simulated nodes; and
a routing daemon;
wherein said routing daemon intercepts incoming packets and determines if an exception rule that applies to said packet exists, said exception rule defining a path between a real node and a simulated node, and, if so, routes said packet according to said exception routing rule.

11. The device of claim 10 wherein one or more ports on said router are connected to real nodes and further wherein one or more ports on said router are connected to network simulators defining one or more simulated nodes.

12. A method for connecting real and simulated network nodes comprising the steps, executed on a computer acting as a standard router of:
a. intercepting incoming data packets;
b. checking a database of exception routing rules to determine if one of said rules applies to said intercepted packet, said rules specifying a destination port to which said packet should be routed;
c. if a rule is found that applies to said intercepted data packet, routing said data packet to said specified destination port; and
d. if a rule is not found that applies to said intercepted data packets, passing said data packet to said routers standard routing protocol.

13. The method of claim 12 wherein the application of said exception routing rules to said incoming data packets are based on one or more of source port, destination node and packet type.

14. The method of claim 13 wherein said exception routing rules allow data packets received from ports connected to real nodes to be sent to data ports connected to network simulators.

15. The method of claim 14 wherein the topology of said simulated networks is contained in a database stored in said router.

16. The method of claim 14 wherein said exception routing rules are contained in a database stored in said router and further wherein said rules are defined by a user to allow the scaling of a small scale network to a large scale network.

17. The method of claim 12 further comprising the steps of:
a. connecting real nodes to one or more ports on said router; and
b. connecting network simulators to one or more ports on aid router.

18. The system of claim 12 further comprising the step of providing a user interface to allow a user to set up said exception routing rules.
